(19) United States
(12) Patent Application Publication
(10) Pub. No.: US 2010/0284487 A1
(43) Pub. Date: Nov. 11, 2010

(54) WIRELESS TRANSMISSION DEVICE AND WIRELESS TRANSMISSION METHOD

(75) Inventors: Atsushi Sumasu, Kanagawa (JP); Isamu Yoshii, Kanagawa (JP); Tomohiro Imai, Kanagawa (JP); Daichi Imamura, Kanagawa (JP); Seigo Nakao, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATIOIIN, Osaka (JP)

(21) Appl. No.: 12/812,449

(22) PCT Filed: Jan. 14, 2009
(86) PCT No.: PCT/JP2009/000111

§ 371 Date: Jul. 9, 2010

(30) Foreign Application Priority Data
Jan. 15, 2008 (JP) 2008-005996

(51) Int. Cl. H04L 27/00

(52) U.S. Cl. 375/295

(57) ABSTRACT

A wireless transmission method for improving the reception characteristic of a preamble. The wireless transmission method allows the patterns of subcarriers (transmitting antenna Tx1: 1, 2, 3, 5, 6, 7, 8, . . . , transmitting antenna Tx2: 4, 9, 10, 12, 13, 14, . . . ) in which preamble sequences are continuously arranged to be changed in a frequency direction. With this, the preamble sequences can be arranged at random subcarrier intervals and, when the autocorrelation values of the preamble sequences are obtained in a time domain, the peak value of the sidelobe becomes small, thereby making it possible to prevent a timing detection error.

### TECHNICAL FIELD

The present invention relates to a radio transmitting apparatus and a radio transmitting method. More particularly, the present invention relates to a method of transmitting preambles.

### BACKGROUND ART

In radio cellular systems as typified by cellular phones and so forth, first, a mobile terminal transmits known signals referred to as “preambles” to a base station (Node-B) in order to access the cellular network. Preambles have two main tasks. One is to identify the mobile terminals in the area (cell) covered by the base station, and the other is to detect differences in transmission timings between mobile terminals.

Since it is difficult for a mobile terminal to adjust transmission timings by itself, the base station is required to detect transmission timings. Now, this will be explained.

As for a cellular system in which operations are divided by time units such as frames, signals transmitted from each mobile terminal in the uplink must be received at timings determined in the base station.

However, since the distance between the cellular system and each mobile terminal is not fixed, timings the base station receives transmitted signals are not synchronized. The reason is that, in a mobile communication system, since pilot signals and control signals are periodically transmitted from the base station in the downlink, it is possible to determine transmission timings based on downlink signals, but the time signals from the base station take to reach each mobile terminal and the time signals from each mobile terminal take to reach the base station vary in proportion to the distance between the base station and each mobile terminal, and consequently the reception timings in the base station vary.

Since it is difficult for a mobile terminal to adjust transmission timings by itself by measuring accurately the radio wave propagation delay time between the mobile terminal and the base station, the base station by receiving preambles detects differences in reception timings and reports transmission timing correction according to differences in reception timings, to each mobile terminal. By this means, transmission timing correction (transmission time alignment) is performed.

Here, since preambles are signals transmitted first from a mobile terminal in order to access the cellular network, the base station does not know when preambles are received. Each mobile terminal determines preamble transmission timings based on downlink signals, so that it is possible to narrow down preamble reception ranges to a certain extent, and, nevertheless the base station needs to receive preambles taking into account variations due to differences in propagation delay between mobile terminals.

The base station detects preambles by finding constantly (or in the entire range taking into account differences in reception timings), correlations between time waveform replicas of all preamble signals, which may be received, and received signals. When a preamble is successfully detected, the detection of the preamble is reported to the corresponding base station with a transmission timing correction value.

Non-Patent Document 1: 3GPP TS 36.211 V8.0.0 (2007-09) “3rd Generation Partnership Project; Technical Specification Group Radio Access Network; Evolved Universal Terrestrial Radio Access (E-UTRA); Physical channels and modulation (Release 8)”, 5.7 Physical random access channel.
Non-Patent Document 2: Journal of the Japan Society for Simulation Technology, JSST-MM2007-20, “Random access burst design and evaluation in Evolved-UTRA”, Daichi IMAMURA, Katsuhiko HIRAMATSU, Tomohumi TAKATA, Takashi IWAI.

### DISCLOSURE OF INVENTION

### Problems to be Solved by the Invention

Here, since it is not possible to know whether or not a preamble has been transmitted until it is detected in the base station, even if detection of a preamble fails, the base station generally does not report undetectable conditions using a NACK and so forth to a mobile terminal.

Therefore, a mobile terminal having transmitted a preamble retransmits a preamble if there is no report from the base station after a predetermined time has passed after the preamble is transmitted. In this case, preamble transmission power is often increased.

However, even if a preamble is retransmitted from a mobile terminal, the base station having failed to detect the first preamble does not know that the first preamble is received, so that combination with the first received signal is not performed unlike HARQ.

Therefore, the base station is required to accurately detect preambles in one reception in order that mobile terminals reduce power consumption and quickly start accessing the cellular network.

In view of the above-described problems, it is therefore an object of the present invention to provide a radio transmitting apparatus and a radio transmitting method that allow improvement of preamble reception characteristics.

### Means for Solving the Problem

One embodiment of the radio transmitting apparatus according to the present invention adopts a configuration including: a preamble sequence generating section that generates preamble sequence signals; a weighting section that weights the preamble sequence signals with weighting vectors using a plurality of antennas; and an arranging section that arranges the weighted preamble sequence signals at random subcarrier intervals.

### ADVANTAGEOUS EFFECTS OF INVENTION

According to the present invention, the number of combinations of subcarriers at equal intervals is reduced, so that it is possible to reduce the periodicity of OFDM symbols in the time domain. As a result of this, correlation values do not have any sidelobes in the time domain, so that preamble reception characteristics are improved and the accuracy of timing detection is improved.

### BRIEF DESCRIPTION OF DRAWINGS

FIG. 1 is a drawing explaining causes of timing detection error;

FIG. 2A is a drawing showing subcarriers to arrange preambles on;

FIG. 2B is a drawing showing autocorrelation characteristics in the time domain;

FIG. 3A is a drawing showing subcarriers to arrange preambles on;

FIG. 3B is a drawing showing autocorrelation characteristics in the time domain;

FIG. 4A is a drawing showing subcarriers to arrange preambles on;

FIG. 4B is a drawing showing autocorrelation characteristics in the time domain;

FIG. 5A is a drawing showing subcarriers to arrange preambles on;

FIG. 5B is a drawing showing autocorrelation characteristics in the time domain;

FIG. 6 is a drawing showing preamble arrangement patterns on subcarriers according to embodiment 1 of the present invention;

FIG. 7 is a drawing showing autocorrelation characteristics in a case in which the preamble arrangement patterns in FIG. 6 are employed;

FIG. 8 is a block diagram showing an exemplary configuration of a transmitting apparatus;

FIG. 9 is a block diagram showing an exemplary configuration of a receiving apparatus;

FIG. 10 is a block diagram showing an exemplary configuration of a transmitting apparatus;

FIG. 11A to FIG. 11E are drawings showing preamble arrangement patterns on subcarriers according to embodiment 2;

FIG. 12 is a drawing showing autocorrelation characteristics in a case in which the preamble arrangement patterns in FIG. 11 are employed;

FIG. 13A and FIG. 13B are drawings showing preamble arrangement patterns on subcarriers according to embodiment 3;

FIG. 14 is a drawing showing autocorrelation characteristics in the time domain in a case in which the preamble arrangement patterns in FIG. 13 are employed;

FIG. 15 is a drawing showing preamble arrangement patterns on subcarriers when there are two transmitting antennas according to embodiment 4;

FIG. 16 is a drawing showing preamble arrangement patterns on subcarriers when there is one transmitting antenna according to embodiment 4; FIG. 17A is a drawing showing exemplary precoding weights used in PVS;

FIG. 17B is a drawing showing antenna arrangement;

FIG. 18 is a drawing showing general preamble arrangement in PVS; and

FIG. 19 is a drawing showing an exemplary preamble arrangement in PVS according to embodiment 5.

### BEST MODE FOR CARRYING OUT THE INVENTION

Now, embodiments of the present invention will be described in detail with reference to the accompanying drawings.

### (1) Study of Diversity Transmission

First, how the present invention has been arrived at will be described prior to descriptions of embodiments of the present invention.

For example, as for IMT-Advanced studied as a next-generation mobile communication system, application of access methods, such as the OFDMA (Orthogonal Frequency Division Multiplexing Access) method or the SC-FDMA (Single-Carrier Frequency Division Multiple Access) method in which channels are configured by collecting a plurality of frequency units (subcarriers) to the uplink is possible. Following embodiments assume that mainly a mobile terminal transmits ODFM or SCFDM signals in which preamble sequences are arranged in the frequency (sub-carrier) direction as preamble signals.

The inventors believe that it is preferable to provide a plurality of transmitting antennas in a mobile terminal and perform diversity transmission in order to improve preamble reception characteristics (preamble detection performance).

In addition, the inventors believe it is preferable to employ, among diversity transmission methods conventionally proposed, PVS (Precoding Vector Switching), CDD (Cyclic Delay Diversity), FSTD (Frequency Switched Transmit Diversity) and TSTD (Frequency Switched Transmit Diversity).

The reason is that PVS, CDD, FSTD and TSTD are diversity transmission methods that allow demodulation even if the base station receiving preambles does not know the number of transmission antennas in each mobile terminal. Although, for example, STBC (Space-Time Block Code) and SFBC (Space-Frequency Block Code) are known as diversity transmission methods that provide good reception characteristics, it is necessary to share information about the number of transmission antennas and the code to apply between the transmitting and receiving sides in advance, so that the inventors believe that STBC and SFBC are not suitable for preamble transmission.

Moreover, among PVS, CDD, FSTD and TSTD, the inventors narrow them down to CDD and FSTD that are methods providing the diversity effect by detecting reception once as the diversity transmission methods used for preamble transmission. Here, the inventors believe that CCD has a possibility to deteriorate preamble reception characteristics in narrow bands, and therefore, believe that FSTD is the most preferred method.

By these studies, the inventors have arrived at a conclusion that FSTD is the most preferred method to use for diversity transmission of preambles. Here, although details will be described later, it is possible to regard FSTD as one variation of a case in which PVS is applied in the frequency direction, so that PVS including FSTD is applied to the present invention.

### (2) Study of Subcarriers to Use

In addition, the inventors study subcarriers to arrange preambles on.

When FSTD is used in diversity transmission, subcarriers at equal intervals are used in each transmission antenna in general. When there are two transmission antennas for example, one antenna transmits signals arranged on only even-numbered subcarriers and the other antenna transmits signals arranged on only odd-numbered subcarriers.

However, since waveforms using subcarriers at equal intervals keep repeat appearing in OFDM symbols, timing detection error occurs. For example, a case will be considered where there are two transmission antennas, one antenna transmits signals in which preambles are arranged on only even-numbered subcarriers and the other antenna transmits signals in which preambles are arranged on only odd-numbered subcarriers.

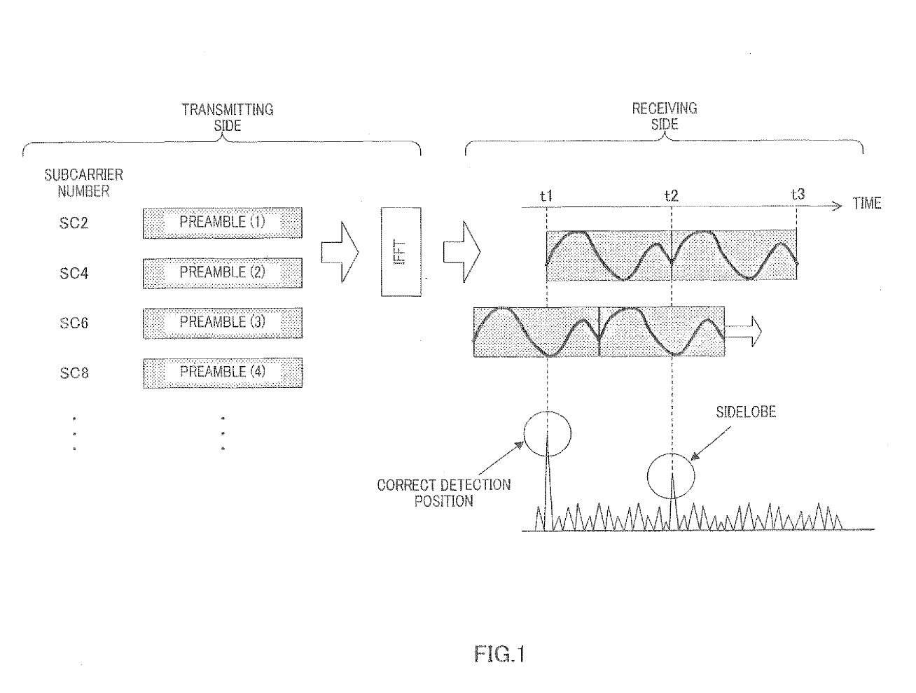

This state is shown in FIG. 1. Although FIG. 1 is a drawing showing a case there is only one antenna for ease of explanation, a case in which there are two antennas is the same. Here, if the number of antennas increases to two, the diversity gain increases accordingly.

As shown in FIG. 1, when preambles are arranged on even-numbered subcarriers SC2, SC4, . . . , and subjected to inverse Fourier transform (IFFT) processing, the first half (period t1 to t2) and the second half (period t2 to t3) of an OFDM symbol have the same waveform. Therefore, when correlation is detected using replicas on the receiving side, correlation peaks of the principal wave occur in two spots (“correct detection position” and “sidelobe” in the figure), so that timing detection error occurs.

Incidentally, when a method other than FSTD in which PVS is applied at equal intervals in the subcarrier direction is employed, a plurality of correlation peaks occur in the same way.

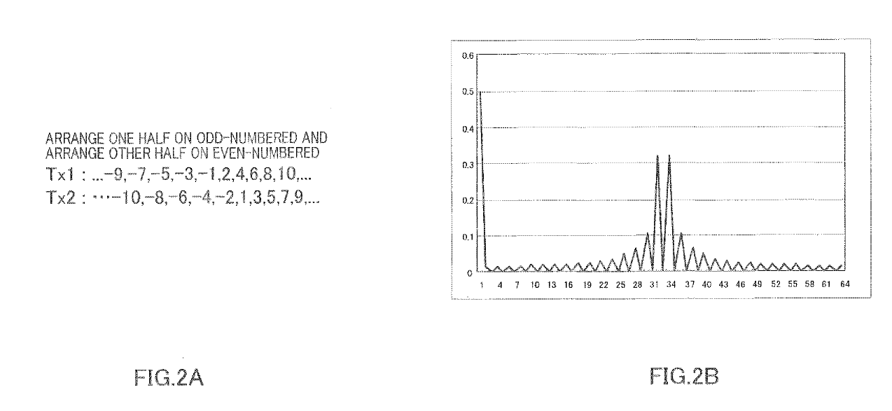

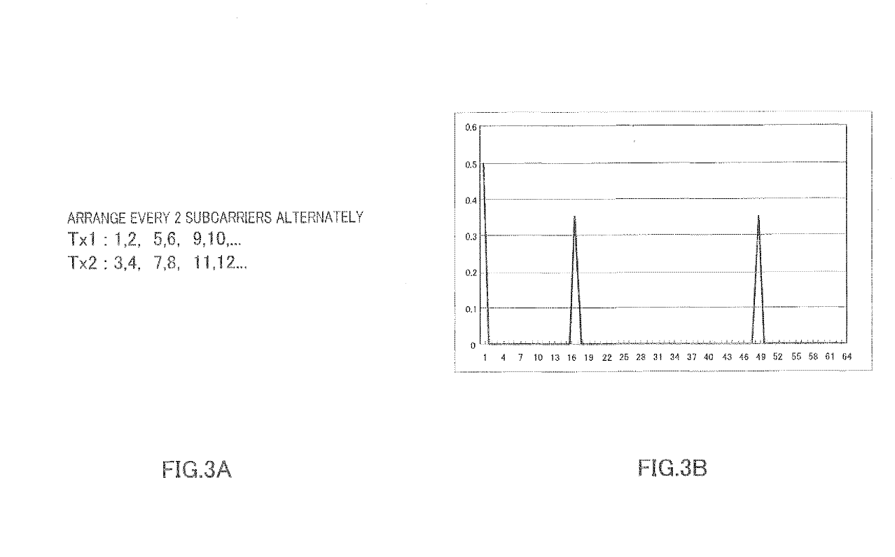

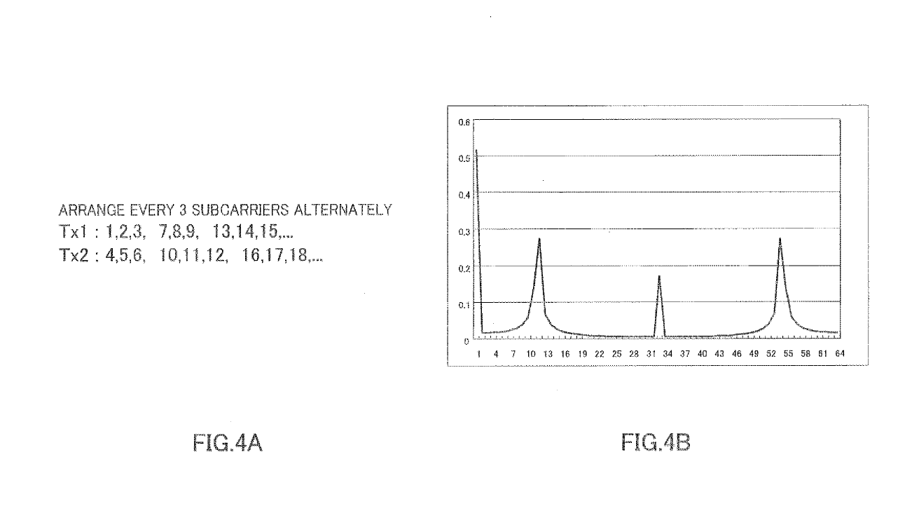

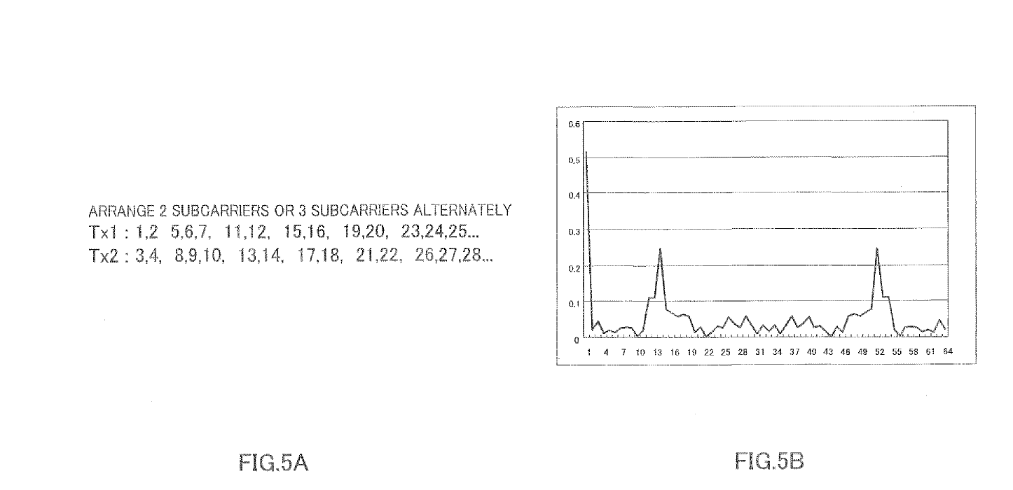

Next, the inventors have studied in detail what preamble arrangement on subcarriers generates sidelobes. This state will be shown in FIG. 2, FIG. 3, FIG. 4 and FIG. 5 as follows. FIG. 2A, FIG. 3A, FIG. 4A and FIG. 5A show on which subcarriers of first transmission antenna. Tx1 and second transmission antenna Tx2 preambles are arranged. FIG. 2B, FIG. 3B, FIG. 4B and FIG. 5B show autocorrelation characteristics obtained on the receiving side. Here, in FIG. 2B, FIG. 3B, FIG. 4B and FIG. 5B, the horizontal axes indicate sampling points in one OFDM symbol period and the vertical axes indicate autocorrelation values.

### Example 1

as shown in FIG. 2A, as for antenna Tx1, preambles are arranged on odd-numbered subcarriers ( . . . , −9, −7, . . . ) in one half of the transmission band and arranged on even-numbered subcarriers (2, 4, . . . ) in the other half of the transmission band. In the same way, as for antenna Tx2, preambles are arranged on even-numbered subcarriers ( . . . , −10, −8, . . . ) in one half of the transmission band and arranged on odd-numbered subcarriers (1, 3, . . . ) in the other half of the transmission band. In this case, as shown in FIG. 2B, a plurality of sidelobes occur in the vicinity of the center in the symbol.

### Example 2

as shown in FIG. 3A, preambles are arranged alternately every two subcarriers in antennas Tx1 and Tx2. In this case, sidelobes occur at two spots sandwiching the center of the symbol as shown in FIG. 3B.

### Example 3

as shown in FIG. 4A, preambles are arranged alternately every three subcarriers in antennas Tx1 and Tx2. In this case, as shown in FIG. 4B, sidelobes occur at the center of the symbol and at two spots sandwiching the center.

### Example 4

as shown in FIG. 5A, preambles are arranged every two subcarriers or three subcarriers in antennas Tx1 and Tx2. In this case, as shown in FIG. 5B, sidelobes occur at two spots sandwiching the center of the symbol.

Based on the above-described experimental results, the inventors believe that the peak value of sidelobes in autocorrelation values of a time waveform becomes higher when the proportion of subcarriers at equal intervals increases in subcarriers to use.

The main feature of the present invention is to randomize subcarrier intervals in which preambles are arranged. In other words, preambles are not arranged, as much as possible, on subcarriers at equal intervals. By this means, since it is possible to reduce the periodicity of OFDM symbols in the time domain, peak values of sidelobes are lower when autocorrelation values of preamble sequences are calculated in the time domain, and consequently it is possible to prevent timing detection error.

### Embodiment 1

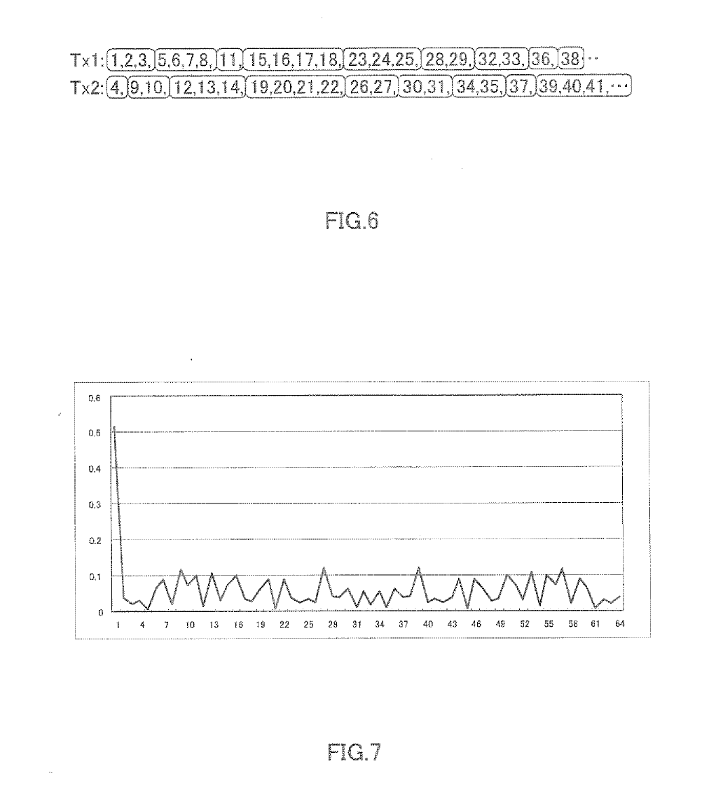

FIG. 6 shows preamble arrangement patterns on subcarriers of OFDM signals according to the present embodiment. With the present embodiment, subcarrier patterns in which preamble sequence signals are consecutively arranged are varied in the frequency direction. To be more specific, preambles are arranged on 1, 2, 3, 5, 6, 7, 8, 11, . . . , 36, 38th, . . . subcarriers transmitted from first transmitting antenna Tx1, and arranged on 4, 9, 10, 12, 13, 14, . . . , 39, 40, 41th, . . . subcarriers transmitted from second transmitting antenna Tx2. Then, the preambles arranged on subcarriers as shown in FIG. 6 are transmitted from antenna Tx1 and antenna Tx2 simultaneously.

Here, as seen from FIG. 6, as for first antenna Tx1, subcarrier patterns in which preambles are consecutively arranged vary in the frequency direction as follows: three consecutive subcarriers (1, 2, 3), four consecutive subcarriers (5, 6, 7, 8), one subcarrier (11), four consecutive subcarriers (15, 16, 17, 18), three consecutive subcarriers (23, 24, 25), two consecutive subcarriers (28, 29), two consecutive subcarriers (32, 33), one subcarrier (36), one subcarrier (38), . . . .

In the same way, as for second antenna Tx2, subcarrier patterns in which preambles are consecutively arranged vary in the frequency direction as follows: one subcarrier (4), two consecutive subcarriers (9, 10), three consecutive subcarriers (12, 13, 14), four consecutive subcarriers (19, 20, 21, 22), two consecutive subcarriers (26, 27), two consecutive subcarriers (30, 31), two consecutive subcarriers (34, 35), one subcarrier (37), three consecutive subcarriers (39, 40, 41), . . . .

Incidentally, as seen from FIG. 6, subcarriers on which preambles are arranged in transmission antenna Tx1 do not have preambles arranged thereon in transmission antenna Tx2, and, on the other hand, subcarriers on which preambles are arranged in transmission antenna Tx2 do not have preambles arranged thereon in transmission antenna Tx1. As thus described, preambles are arranged complementarily between antennas. That is, with the present embodiment, FSTD is employed as a diversity transmission method.

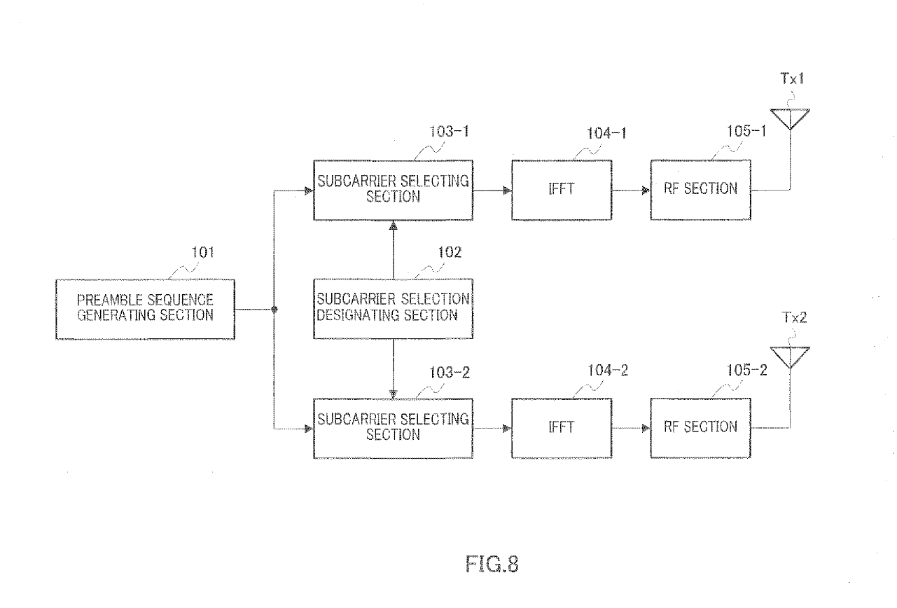

FIG. 7 shows autocorrelation characteristics of preambles on the receiving side when preambles are arranged as in FIG. 6. As seen from FIG. 7, although a large peak appears at the beginning position in the symbol, other large peaks do not occur. Therefore, it is possible to prevent timing detection error.

FIG. 8 shows an exemplary configuration of a transmitting apparatus to perform the above-described transmitting method. The transmitting apparatus in FIG. 8 is mounted in, for example, a mobile terminal. Here, although only components related to preamble transmission are shown in FIG. 8, a control signal transmission system configured by a pilot signal transmission system and a data transmission system composed of a coding section, modulating section and so forth are mounted in actual mobile equipment.

Preamble sequence signals generated in preamble sequence generating section 101 are inputted to transmitting antenna systems of antenna Tx1 and antenna Tx2. Here, preamble sequence signals are generated to differ between, for example, terminals.

Subcarrier selecting sections 103-1 and 103-2 arrange preamble sequences in subcarrier positions used (IFFT input positions) in accordance with commands from subcarrier selection designating section 102 and outputs these preamble sequences to IFFTs 104-1 and 104-2.

To be more specific, subcarrier selecting section 103-1 arranges preamble sequences in subcarrier positions shown in Tx1 in FIG. 6 and outputs these preamble sequences, and subcarrier selecting section 103-2 arranges preamble sequences in subcarrier positions shown in Tx2 in FIG. 6 and outputs these preamble sequences.

IFFTs (Inverse Fourier Transform sections) 104-1 and 104-2 form OFDM signals as time waveform signals by performing inverse Fourier transform on signals inputted from subcarrier selecting sections 103-1 and 103-2. OFDM signals are subjected to radio processing by RF sections 105-1 and 105-2, and then transmitted from antennas Tx1 and Tx2.

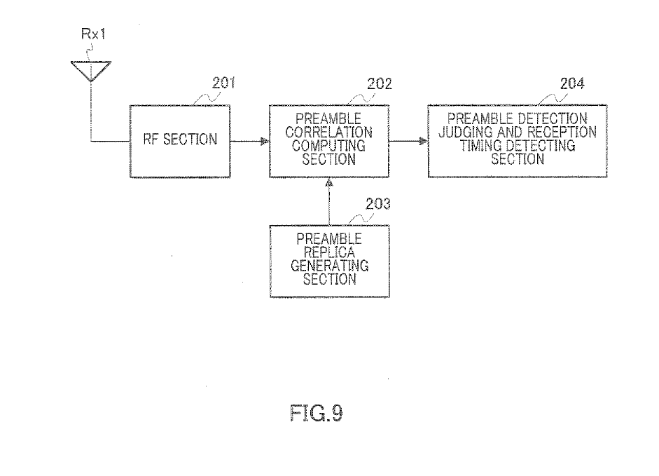

FIG. 9 shows an exemplary configuration of a receiving apparatus that receives preambles transmitted from transmitting apparatus shown in FIG. 8. The receiving apparatus in FIG. 9 is mounted, for example, in the base station. Here, although components related preamble reception are shown in FIG. 9, a data receiving system composed of a demodulating section, a decoding section and so forth is mounted in an actual base station.

Signals received at antenna Rx1 are subjected to radio processing by RF section 201, and then inputted to preamble correlation computing section 202. Preamble replica producing section 203 produces or holds all time waveform replicas of preamble sequences likely to be received and provides them to preamble correlation computing section 202.

Preamble correlation computing section 202 calculates correlations between time waveform replicas of preamble sequences which are provided and received signals (i.e. autocorrelation values). Preamble detection judging and reception timing detecting section 204 judges which preambles are detected and detects differences between the timings these preambles are received based on the presence or absence of and the positions of correlation peaks equal to or higher than the threshold of autocorrelation values obtained in preamble correlation computing section 202.

Here, since it is possible to prevent occurrence of a plurality of peaks equal to or higher than the threshold in one OFDM symbol by using the above-described preamble arrangement, it is possible to detect differences in reception timings without error.

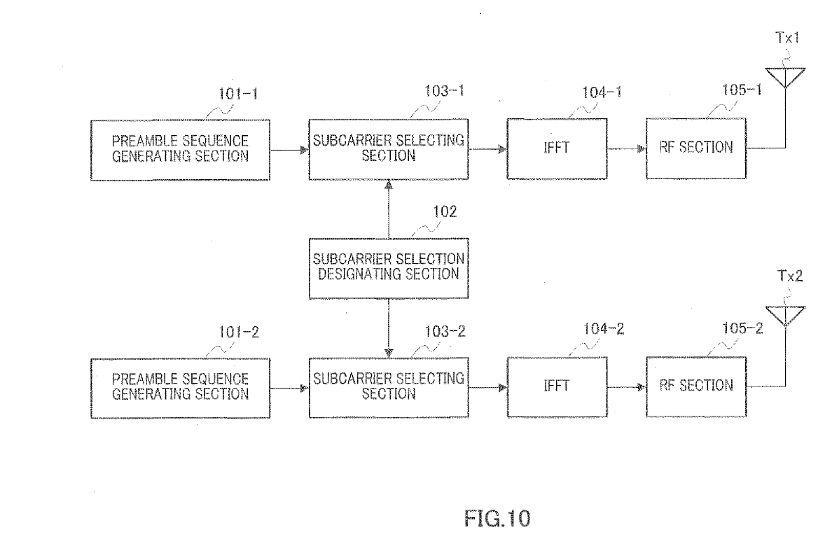

Here, although preamble sequences generated in one preamble sequence generating section 101 are used in transmitting antenna systems of both antenna Tx1 and antenna Tx2 in FIG. 8, another configuration may be applicable where preambles for the transmission system of antenna Tx1 are generated in preamble sequence generating section 101-1 and preambles for the transmission system of antenna Tx2 are generated in preamble sequence generating section 101-2 as shown in FIG. 10. That is, it may be possible to transmit individual preamble sequences per transmitting antenna system.

In addition, a receiving apparatus may receive preamble sequences using one antenna or a plurality of antennas as shown in FIG. 9.

As described above, according to the present embodiment, it is possible to arrange preamble sequences at random subcarrier intervals by varying subcarrier patterns in which preamble sequences are consecutively arranged in the frequency direction. By this means, when the autocorrelation values of preamble sequences are calculated in the time domain, the peak values of sidelobes are lower, so that it is possible to prevent timing detection error.

Moreover, by applying FSTD as the diversity transmission method, it is possible to obtain the diversity effect by detecting reception once, so that efficient preamble transmission is possible.

### Embodiment 2

With the present embodiment, it will be presented that preamble sequence signals are arranged on subcarriers having the same patterns as PN sequences. The present embodiment proposes using particularly a Gold sequence which has a length to match the number of subcarriers and which contains the same number of “1” bits and “0” bits as a PN sequence; associating the subcarrier arrangement with the arrangement pattern of the gold sequence; and arranging preamble sequence signals on subcarriers corresponding to the positions of “1” bits or positions of “0” bits in the Gold sequence.

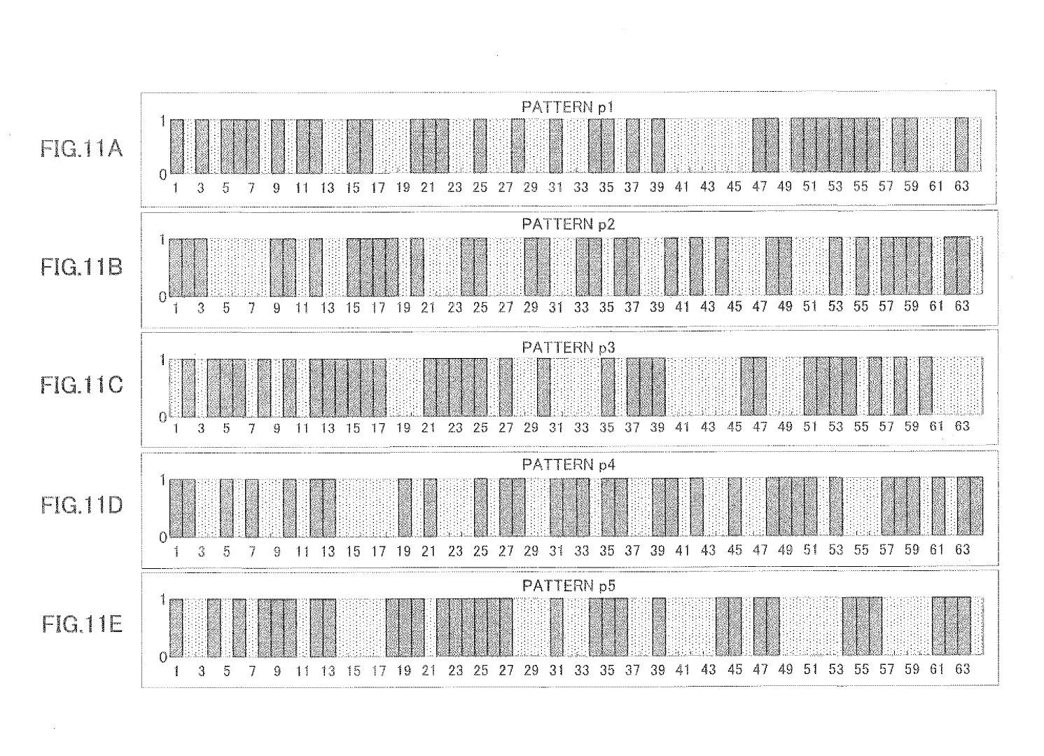

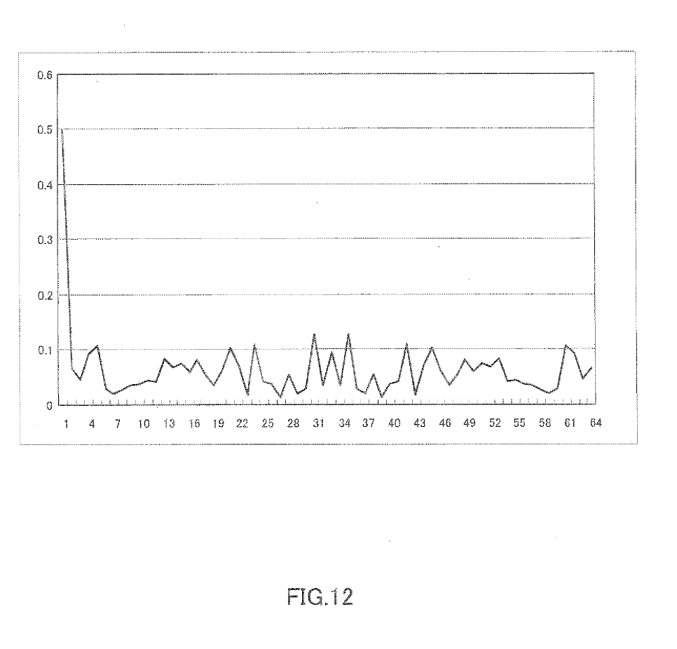

FIG. 11 shows examples of preamble arrangement patterns on subcarriers created using Gold sequences. FIG. 11 shows examples of cases in which the number of subcarriers is sixty-four. In these cases, a configuration is adopted where Gold sequences of 64 bits are generated and the same number of “1” bits and “0” bits are generated. Gold sequences and subcarrier arrays are matched, and preamble sequences are arranged on subcarriers in the positions of “bit=1” (subcarriers shown black in the figures) in Gold sequences.

Among subcarriers transmitted from antenna Tx1, preamble sequences are arranged on subcarriers shown black in FIG. 11A, FIG. 11B, FIG. 11C, FIG. 11D or FIG. 11E. Then, as for subcarriers to transmit from antenna Tx2, preamble sequences may be arranged on subcarriers on which preamble sequences are not arranged thereon in antenna Tx1.

For these operations, subcarrier selection designating section 102 in FIG. 8 may generate Gold sequences, and subcarrier selecting sections 103-1 and 103-2 may select subcarriers based on these Gold sequences.

FIG. 12 shows autocorrelation characteristics of preambles on the receiving side when the subcarrier arrangements shown in FIG. 11A, FIG. 11B, FIG. 11C, FIG. 11D or FIG. 11E are applied. As seen from FIG. 12, although a large peak appears in the beginning position in the symbol, other large peaks do not appear. Therefore, it is possible to prevent timing detection error.

In addition, it is possible to significantly reduce cross-correlation characteristics among patterns p1 to p5 in FIG. 11, so that it is possible to obtain an effect of preventing interference between cells when, for example, patterns p1 to p5 are applied to preamble arrangement in different cells.

### Embodiment 3

The present embodiment proposes using an M sequence having a length resulting from subtracting DC (direct current) subcarriers from the number of subcarriers as a PN sequence; associating the subcarrier arrangement with the arrangement pattern of the M sequence; and arranging preamble sequences on subcarriers corresponding to the positions of “0” bits in the M sequence.

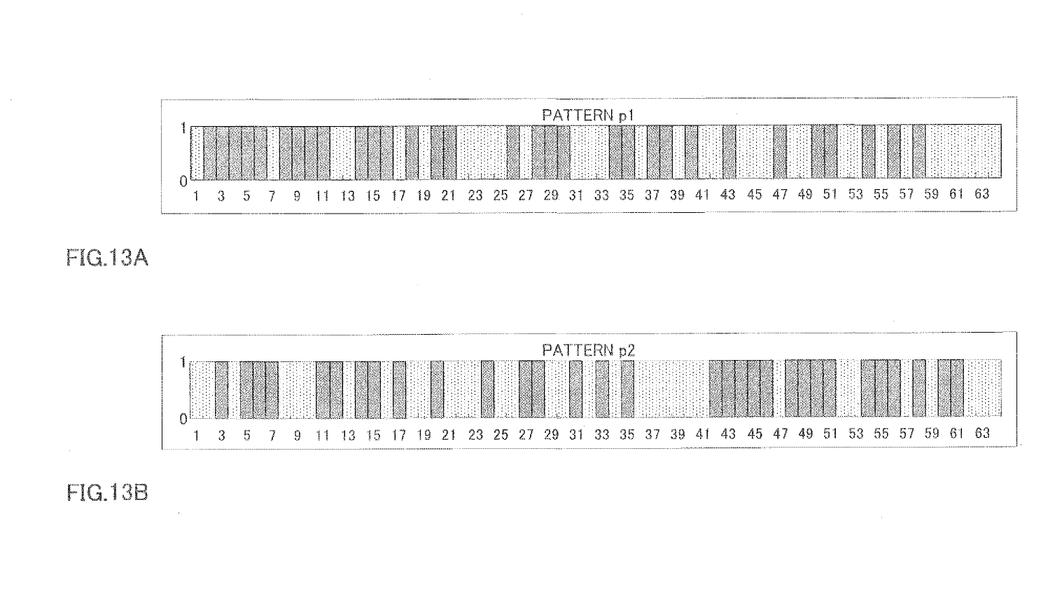

FIG. 13 shows examples of preamble arrangement patterns on subcarriers created using M sequences. M sequences and subcarrier arrays are matched, and preamble sequences are arranged on the subcarriers in the positions of “bit=0” (subcarriers shown black in the figure).

Among subcarriers transmitted from antenna Tx1, preamble sequences are arranged on the subcarriers shown black in FIG. 13A or FIG. 13B. Then, as for subcarriers transmitted from antenna Tx2, preambles may be arranged on the subcarriers on which preambles are not arranged thereon in antenna Tx1.

For these operations, subcarrier selection designating section 102 in FIG. 8 may generate M sequences, and subcarrier selecting sections 103-1 and 103-2 may select subcarriers based on these M sequences.

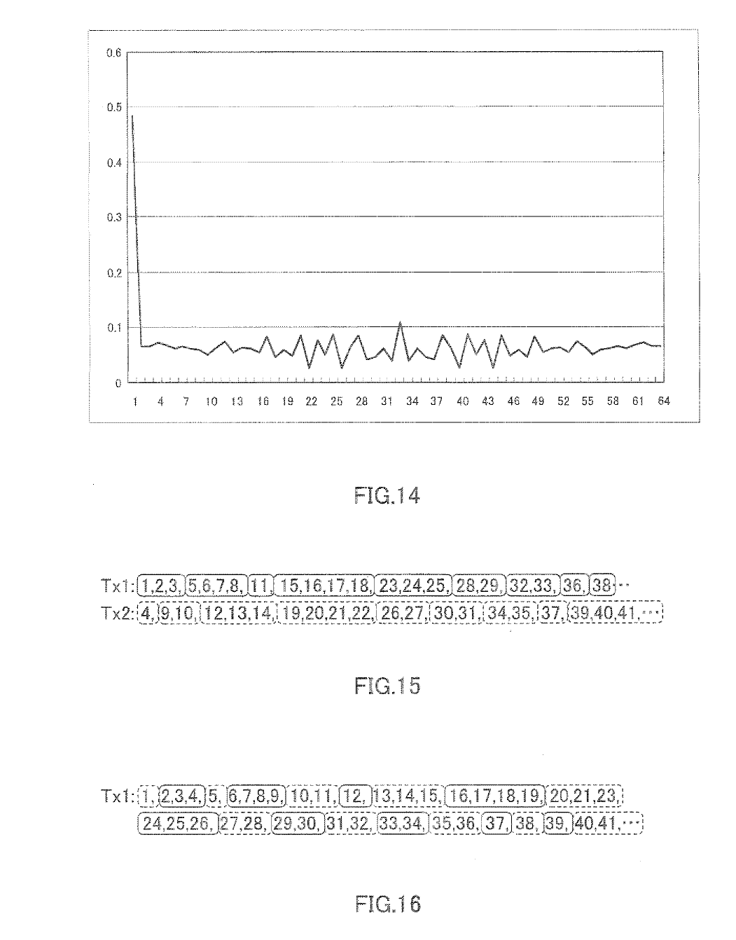

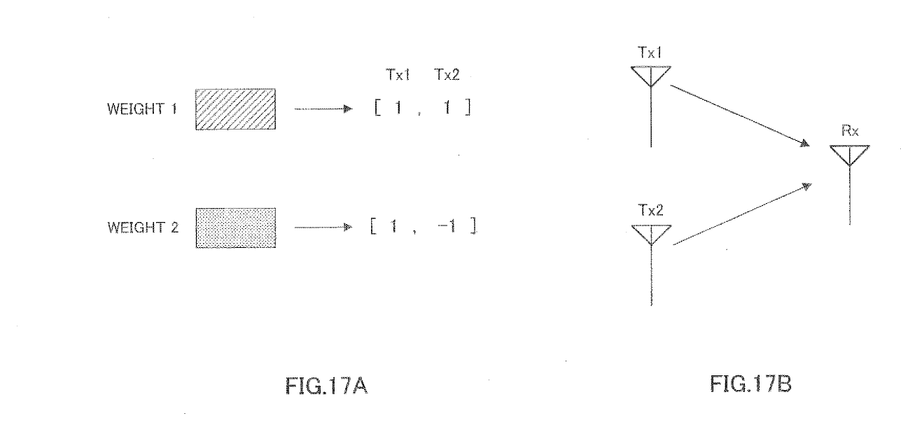

FIG. 14 shows autocorrelation characteristics of preambles on the receiving side when the subcarrier arrangement shown in FIG. 13A or FIG. 13B is applied. As seen from FIG. 14, although a large peak appears in the beginning position in the symbol, other large peaks do not appear. Therefore, it is possible to prevent timing detection error.

In addition, it is possible to significantly reduce cross-correlation characteristics between patterns p1 and p2 in FIG. 13, so that it is possible to obtain an effect of preventing interference between cells when, for example, patterns p1 and p2 are applied to preamble arrangements in different cells.

By the way, often center subcarriers are not used in OFDM because center subcarriers are influenced by DC offset. Since the sequence length of M sequences is 2n−1 (n: natural number), M sequences easily match OFDM subcarriers not using DC subcarriers. In addition, since M sequences have approximately the same number of “0” bits and “1” bits (the number of “0” bits is certainly less than the number of “1” bits by one), there is not a trouble to select sequences in which the same number of “1” bits and “0” bits are generated unlike Gold sequences, so that M sequences are suitable to arrange the same number of preambles on subcarriers between a plurality of antennas.

### Embodiment 4

With the present embodiment, a preamble arrangement method in which it is possible to determine the number of transmission antennas on the receiving side will be described.

As shown in FIG. 15 and FIG. 16, it is possible to determine the number of transmission antennas on the receiving side by shifting subcarriers to arrange preambles on, in accordance with the number of transmission antennas.

FIG. 15 shows preamble arrangement patterns on subcarriers when the number of transmission antennas is two and shows the same arrangement explained as with FIG. 6. On the other hand, FIG. 16 shows preamble arrangement patterns on subcarriers when the number of transmission antennas is one. In the preamble arrangement patterns in FIG. 16, preambles are arranged on subcarriers shifted by one subcarrier as compared to the preamble arrangement patterns of FIG. 15.

By this means, since the time waveform varies in accordance with the number of transmission antennas even if the same preamble sequences are used, it is possible to determine the number of transmission antennas by preparing a plurality of replicas matching the number of antennas.

Incidentally, if it is possible to determine the number of transmission antennas, it is possible to perform channel estimation for each transmission antenna, so that it is possible to utilize the estimation result to perform channel compensation for signals transmitted next from mobile terminal (e.g. random access signals).

### Embodiment 5

Although cases in which the present invention is applied to FSTD have been described in the above-described embodiments 1 to 4, the present invention is applicable to a case in which preambles are subjected to PVS (precoding vector switching) processing in the frequency direction. In this case, the range in which precoding vector switching processing is performed in the frequency direction may be determined in the same way to select preamble arrangement patterns of embodiments 1 to 4.

FIG. 17 shows examples of precoding weights used in PVS when there are two transmission antennas. In FIG. 17A, weight 1 indicates that two antennas both transmit signals in the same phase, and weight 2 indicates that signals transmitted from the second transmitting antenna are in the phase opposite to the phase of signals transmitted from the first transmitting antenna.

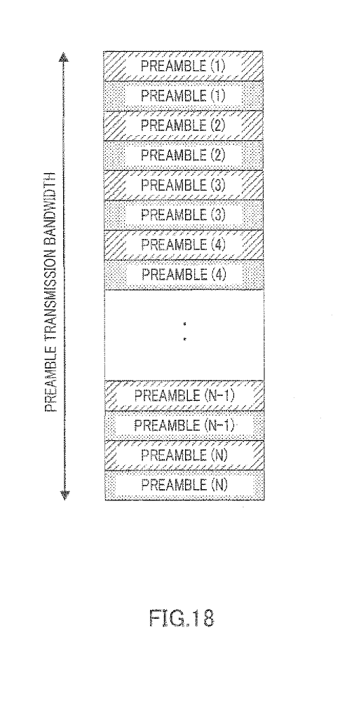

FIG. 18 is a schematic diagram showing a case in which PVS is applied in the frequency direction. Here, the same preamble sequences are arranged on odd-numbered subcarriers and even-numbered subcarriers, and in-phase weighting is performed on odd-numbered subcarriers and opposite phase weighting is performed on even-numbered subcarriers. In this case, when preamble correlation is detected in the base station (receiving side), correlation computation is performed using replicas created with only odd-numbered subcarriers and replicas created with only even-numbered subcarriers, so that sidelobes occur in positions other than the correct detection positions.

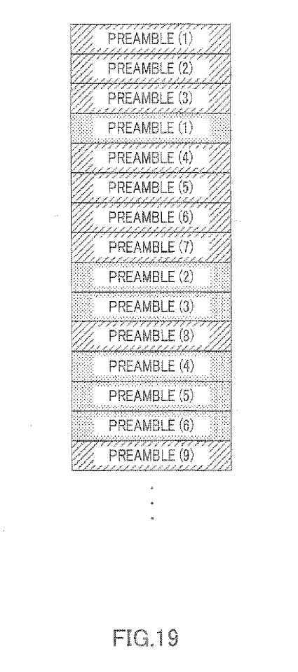

FIG. 19 shows an example of weight arrangement to suppress sidelobes while PVS is performed according to the present embodiment. Weight arrangement patterns are the same as in embodiment 1, and here, weight 1 is applied to subcarriers to arrange preambles on in transmission antenna Tx1 of embodiment 1, and weight 2 is applied to subcarriers to arrange preambles on in transmission antenna Tx2 of embodiment 1. By this means, it is possible to obtain the same effect of preventing timing detection error as in embodiment 1.

Here, it may be possible to regard FSTD of embodiments 1 to 4 as one variation in which PVS is applied in the frequency direction. Expressed in general terms, when PVS is applied in the frequency direction, [a1, a2] and [b1, b2] are used as weight [Tx1, Tx2]. With the present embodiment, a case in which [1, 1] and [1, −1] are used has been explained as one specific example. This is equivalent to use of [1, 0] and [0,1] as weights in FSTD.

That is, as for the methods explained with embodiments 1 to 5, it is possible to say that preamble sequence signals are generated, these preamble sequence signals are weighted with weighting vectors using a plurality of antennas, and the weighted signals are arranged at random subcarrier intervals. For example, as for the configuration in FIG. 8, it is possible to say that subcarrier selection designating section 102 and subcarrier selecting sections 103-1 and 103-2 carry out a function as a weighting means, in addition to a function as a subcarrier arrangement means.

Moreover, as for the methods explained with embodiments 1 to 5, it is possible to say that a weighting means performs first weighting to generate first weighted signals by performing first weighting on first preamble sequence signals or second preamble sequence signals and performs second weighting to generate second weighted signals by performing second weighting on the first preamble sequence signals or second preamble sequence signals; and an arrangement means arranges the first weighted signals and the second weighted signals individually at random subcarrier intervals such that subcarriers to arrange the first weighted signals on and subcarriers to arrange the second weighted signals on do not overlap. Here, it is possible to say that FSTD uses weighting vectors including weighting vectors with zero weight.

### Another Embodiment

Here, with the above-described embodiments, although cases in which there are two antennas have been explained, the above-described preamble transmitting method is applicable to a case in which preambles are transmitted using more than two antennas. For example, when there are four antennas that transmit preambles, it is possible to make preamble arrangements divided into four, that is, make preamble arrangements for four transmitting antennas, by first multiplying subcarriers to arrange preambles on by PN sequences and dividing into halves, as having been explained with the above-described embodiments, and next, multiplying the preamble arrangements divided into halves by PN sequences again and dividing into halves. By this means, it is possible to prevent generation of sidelobes in autocorrelation characteristics in time waveforms of preambles transmitted from each transmitting antenna.

In addition, with the above-described embodiments, although cases in which FSTD is used have been explained as a diversity transmission method, the present invention is not limited to this, and, when the present invention is applied to a case in which preamble sequences are transmitted from, for example, one antenna, it is possible to obtain the same effect as in the above-described embodiments. Here, the preamble arrangements using Gold sequence and M sequence patterns of embodiments 2, 3 and 4 allow random arrangement of the same number of preambles in both transmitting antennas, and therefore are particularly effective for a case in which FSTD is used.

Moreover, although cases have been described with the embodiments above where the present invention is configured by hardware, the present invention may be implemented by software.

Each function block employed in the description of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2008-005996, filed on Jan. 15, 2008, including the specification, drawings and abstract, is incorporated herein by reference in its entirety

### INDUSTRIAL APPLICABILITY

The present invention provides an effect of improving the accuracy of timing detection based on preambles and is applicable to, for example, mobile terminals.

1. A radio transmitting apparatus comprising:
a preamble sequence generating section that generates preamble sequence signals;
a weighting section that weights the preamble sequence signals with weighting vectors using a plurality of antennas; and
an arranging section that arranges the weighted preamble sequence signals at random subcarrier intervals.

2. The radio transmitting apparatus according to claim 1, wherein:
the weighting section generates first weighted signals by performing first weighting on first preamble sequence signals or second preamble sequence signals, and generates second weighted signals by performing second weighting on the first preamble sequence signals or the second preamble sequence signals; and
the arranging section arranges the first weighted signals and the second weighted signals individually at random subcarrier intervals such that subcarriers to arrange the first weighted signals on and subcarriers to arrange the second weighted signals on, do not overlap.

3. The radio transmitting apparatus according to claim 1, wherein the weighting vectors include a weighting vector having zero weight.

4. The radio transmitting apparatus according to claim 1, wherein the arranging section varies subcarrier patterns in which the preamble sequence signals are consecutively arranged in a frequency direction.

5. The radio transmitting apparatus according to claim 1, wherein the arranging section arranges the preamble sequence signals on subcarriers having the same patterns as pseudorandom noise sequences.

6. The radio transmitting apparatus according to claim 5, wherein the arranging section uses a Gold sequence which has a length to match the number of subcarriers and which contains the same number of bits of 1's and bits of 0's as a pseudorandom noise sequence, associates a subcarrier arrangement with an arrangement pattern of the gold sequence and arranges the preamble sequence signals on subcarriers corresponding to the positions of bits of 1's or positions of bits of 0's in the Gold sequence.

7. The radio transmitting apparatus according to claim 5, wherein the arranging section uses an M sequence having a length resulting from subtracting direct current subcarriers from the number of subcarriers as a pseudorandom noise sequence, associates a subcarrier arrangement with an arrangement pattern of the M sequence and arranges preamble sequences on subcarriers corresponding to the positions of bits of 0's in the M sequence.

8. The radio transmitting apparatus according to claim 1, wherein the arranging section shifts subcarriers to arrange the preamble sequence signals on, in a frequency direction, in accordance with the number of transmission antennas.

9. A radio transmitting method comprising:
a preamble sequence generating step to generate preamble sequence signals;
a weighting step to weight the preamble sequence signals with weighting vectors using a plurality of antennas; and
an arranging step to arrange the weighted preamble sequence signals at random subcarrier intervals.

10. The radio transmitting method according to claim 9, wherein:
the weighting step generates first weighted signals by performing first weighting on first preamble sequence signals or second preamble sequence signals, and generates second weighted signals by performing second weighting on the first preamble sequence signals or the second preamble sequence signals; and
the arranging step arranges the first weighted signals and the second weighted signals individually at random subcarrier intervals such that subcarriers to arrange the first weighted signals on and subcarriers to arrange the second weighted signals on, do not overlap.

11. The radio transmitting method according to claim 9, wherein the weighting vectors include a weighting vector having zero weight.

12. The radio transmitting method according to claim 9, wherein the arranging step varies subcarrier patterns in which the preamble sequence signals are consecutively arranged in a frequency direction.

13. The radio transmitting method according to claim 9, wherein the arranging step arranges the preamble sequence signals on subcarriers having the same patterns as pseudorandom noise sequences.

14. The radio transmitting method according to claim 13, wherein the arranging step uses a Gold sequence which has a length to match the number of subcarriers and which contains the same number of bits of 1's and bits of 0's as a pseudorandom noise sequence, associates a subcarrier arrangement with an arrangement pattern of the gold sequence and arranges the preamble sequence signals on subcarriers corresponding to the positions of bits of 1's or positions of bits of 0's in the Gold sequence.

15. The radio transmitting method according to claim 13, wherein the arranging step uses an M sequence having a length resulting from subtracting direct current subcarriers from the number of subcarriers as a pseudorandom noise sequence, associates a subcarrier arrangement with an arrangement pattern of the M sequence and arranges preamble sequences on subcarriers corresponding to the positions of bits of 0's in the M sequence.
